(19) United States
(12) Patent Application Publication
(10) Pub. No.: US 2007/0218874 A1
(43) Pub. Date: Sep. 20, 2007

(54) Systems and Methods For Wireless Network Forensics

(75) Inventors: Amit Sinha, Marlborough, MA (US); Lakshmaiah Regoti, Cumming, GA (US); Kailash Kailash, San Jose, CA (US)

Correspondence Address: FISH & RICHARDSON P.C., P.O BOX 1022, Minneapolis, MN, 55440-1022, US

(73) Assignee: AirDefense, Inc., Alpharetta, GA (US)

(21) Appl. No.: 11/276,930

(22) Filed: Mar. 17, 2006

(51) Int. Cl. H04M 1/66; H04M 1/68; H04M 3/16

(52) U.S. Cl. 455/411

(57) ABSTRACT

Systems and methods for wireless forensics. Systems and methods can store data received from a wireless network. The data is stored utilizing differential records, thereby enabling query and expression processing.

### CROSS-REFERENCE

This application further incorporates by this reference in their entirety for all purposes commonly assigned U.S. patent applications filed Jun. 3, 2002:

| Application | |
|---|---|
| No. | Title |
| 10/161,142 | “SYSTEMS AND METHODS FOR NETWORK |
| | SECURITY” |
| 10/161,440 | “SYSTEM AND METHOD FOR WIRELESS LAN |
| | DYNAMIC CHANNEL CHANGE WITH HONEYPOT |
| | TRAP” |
| 10/161,443 | “METHOD AND SYSTEM FOR ACTIVELY |
| | DEFENDING A WIRELESS LAN AGAINST |
| | ATTACKS” |
| 10/160,904 | “METHODS AND SYSTEMS FOR IDENTIFYING |
| | NODES AND MAPPING THEIR LOCATIONS” |
| 10/161,137 | “METHOD AND SYSTEM FOR ENCRYPTED |
| | NETWORK MANAGEMENT AND INTRUSION |
| | DETECTION” |

Furthermore, this application incorporates by reference for all purposes, commonly assigned U.S. patent applications filed Nov. 4, 2003:

| Application | |
|---|---|
| No. | Title |
| 10/700,842 | “SYSTEMS AND METHODS FOR AUTOMATED |
| | NETWORK POLICY EXCEPTION DETECTION AND |
| | CORRECTION” |
| 10/700,914 | “SYSTEMS AND METHOD FOR DETERMINING |
| | WIRELESS NETWORK TOPOLOGY” |
| 10/700,844 | “SYSTEMS AND METHODS FOR ADAPTIVELY |
| | SCANNING FOR WIRELESS COMMUNICATIONS” |

Furthermore, this application incorporates by reference for all purposes, commonly assigned U.S. patent applications filed Feb. 6, 2004:

| Application | |
|---|---|
| No. | Title |
| 10/774,034 | “SYSTEMS AND METHODS FOR ADAPTIVE |
| | LOCATION TRACKING” |
| 10/774,111 | “WIRELESS NETWORK SURVEY SYSTEMS AND |
| | METHODS” |
| 10/773,896 | “SYSTEMS AND METHODS FOR ADAPTIVE |
| | MONITORING WITH BANDWIDTH CONSTRAINTS” |
| 10/773,915 | “DYNAMIC SENSOR DISCOVERY AND SELECTION |
| | SYSTEMS AND METHODS” |

Furthermore, this application incorporates by reference for all purposes, commonly assigned U.S. patent application filed Oct. 19, 2005:

| Application | |
|---|---|
| No. | Title |
| 11/253,316 | “PERSONAL WIRELESS MONITORING AGENT” |

Furthermore, this application incorporates by reference for all purposes, commonly assigned U.S. patent application filed Jan. 13, 2006:

| Application | |
|---|---|
| No. | Title |
| 11/332,065 | “SYSTEMS AND METHODS FOR WIRELESS |
| | INTRUSION DETECTION USING SPECTRAL |
| | ANALYSIS” |

Furthermore, this application incorporates by reference for all purposes, commonly assigned U.S. patent application filed on Mar. 17, 2006:

| Application | |
|---|---|
| No. | Title |
| TBD | “SYSTEMS AND METHODS FOR WIRELESS |
| | SECURITY USING DISTRIBUTED COLLABORATION |
| | OF WIRELESS CLIENTS” |

### BACKGROUND AND SUMMARY

This disclosure relates to wireless network security systems and methods, and more particularly to systems and methods for implementing forensics to store and retrieve wireless network behavior.

Unauthorized rogue devices, particularly rogue APs, can pose a challenge for wireless network security. According to some analysis, there may be tens of thousands of rogue devices deployed in enterprise wireless networks nationwide. A rogue AP can be, for example, a soft AP, hardware AP, laptop, scanner, projector, or other device. Rogue devices can provide an entry point to a local area network infrastructure, thereby bypassing wired security measures.

Wireless devices have constantly shifting network relationships with other wireless devices. Accidental association can take place when a wireless laptop running Microsoft Windows (available from Microsoft Corporation, Redmond, Wash.) or a wrongly configured client automatically associates and connects to a station in a neighboring network. This can enable intruders to connect to an authorized user's computer without their knowledge, thereby compromising sensitive documents on the user computer, and exposing the user's computer to exploitation. Moreover, if the computer is connected to a wired network, the wired network can be exposed to the intruder.

These types of ad hoc networks are peer-to-peer connections between devices with WLAN cards that do not require an AP or any form of authentication from other user stations.

While these ad-hoc networks can be convenient for transferring files between stations or to connect to network printers, they lack security, thereby enabling hackers to compromise an authorized station or laptop.

Because wireless networks use the air for transmission, conditions and events can change how the WLAN operates. An example is radio frequency (RF) interference, which can cause inoperability in the wireless network and excessive retransmissions of data. The source of RF interference can be another electronic device operating in the area. Wireless networks have limited transmission capacity that is shared between all users associated to a single AP. Hackers can easily launch a denial of service attack on such limited resources.

Rogue APs or other devices can interfere with the operation of authorized devices, and in addition, provide hackers with an interface to a corporate network. A hacker may try to access network resources by intentionally installing a rogue AP to intercept sensitive information or fake a connection to a legitimate AP. In addition, somebody wanting to restrict usage of the wireless network could try jamming an AP with strong radio signals.

Wireless intrusion protection systems (WIPS) have been developed to monitor and secure wireless networks by identifying rogue wireless networks and devices, detecting intruders and impending threats, and enforcing wireless network security policies. A WIPS can include one or more servers connected to monitoring devices distributed throughout the physical space of the wireless network. Examples of distributed monitoring devices include sensors, APs, and clients running monitoring agent software.

Sensors can monitor the wireless network and relay data, events, and statistics to the WIPS server for correlation and aggregation. Additionally, WIPS may use APs and client devices configured with software agents to monitor the wireless network. The APs may monitor the wireless network periodically to provide additional monitoring resources over a dedicated sensor. Also, client devices in the wireless network may be configured with a software agent which performs monitoring responsive to the client device being idle.

The WIPS server receives and correlates data, events, and statistics from the sensors, APs, and clients to detect attacks/events, performance degradation, and policy compliance. The server receives data, events, and statistics from all the sensors, APs, and clients configured with software agents. The server can store the monitored data, events, and statistics in a datastore. However, this can become difficult as the size of the wireless network and the corresponding number of APs, sensors, and clients grows. This can result in the monitored data being discarded or in storing a subset of the actual data.

Wireless forensic investigation tools can be used to analyze data, events, and statistics to determine if and when an attack occurred and to troubleshoot sources of performance degradation. Forensic tools can be used to re-create an entire virtual RF environment, simulating the behavior of all the wireless devices and their behavior in any given time span in the past.

This disclosure includes systems and methods for wireless network forensics. Systems and methods can include efficiently storing all relevant information about the wireless network and devices along with methods to retrieve, analyze and organize the information. Systems and methods can include a differential data storage format to store behaviors, events, and statistics associated with the wireless devices in a monitored space. Additionally, this disclosure provides systems and methods to query, retrieve, and process the information in the data storage to: report through graphs, reports, or alarms; to re-create past behavior of a wireless device; to create new attack definitions; or, to define wireless policies.

### BRIEF DESCRIPTION OF THE DRAWINGS

FIG. 1 depicts a wireless network and a wireless security system.

FIG. 2 is a block diagram depicting a wireless security system with distributed monitoring devices and a server configured for wireless network forensics.

FIG. 3 is a block diagram depicting a server having a forensic engine connected to a datastore.

FIGS. 4A-C depict block diagrams of an absolute record, a differential record, and a record file store.

FIG. 5 depicts an example of the hierarchy of the types of variables associated with monitoring a wireless network that can be stored in the data store.

FIG. 6 depicts a block diagram of an embodiment of a forensic analysis engine.

FIG. 7 illustrates an example screen shot of a forensic user interface (UI) screen.

FIG. 8 illustrates an example screen shot of a forensic user interface (UI) screen depicting graphs and summary views of an example query.

### DETAILED DESCRIPTION

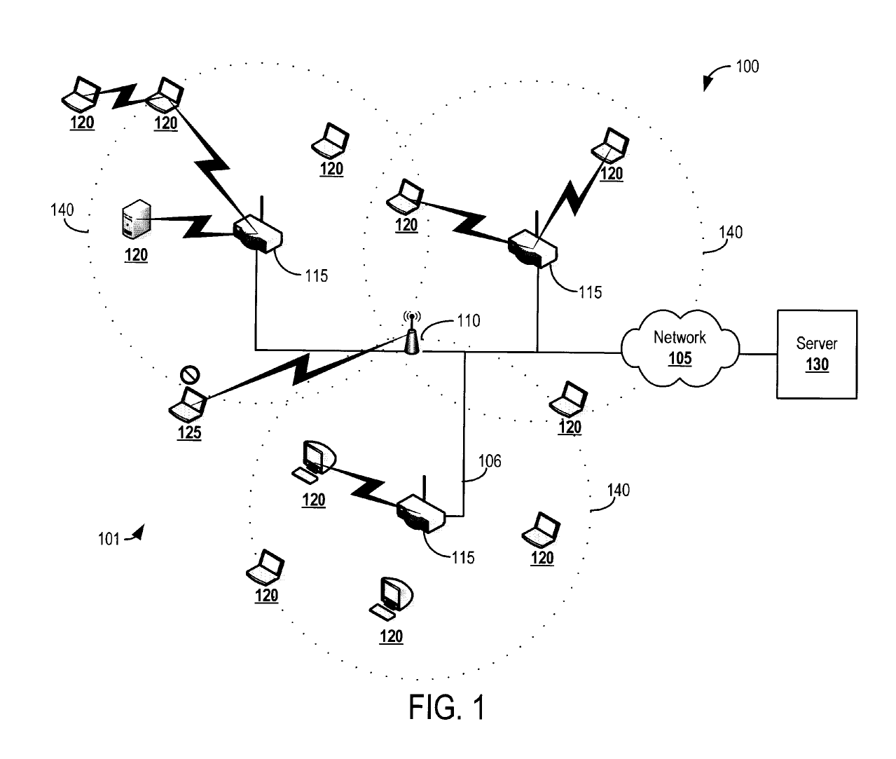

FIG. 1 depicts a wireless network 100 and a wireless security system 101. The wireless network 100, in this example, include three wireless access points (APs) 115. The APs 115 include a wireless radio configured to transmit and receive wireless data within a coverage area 140. In this example, the APs 115 can connect to a local area network (LAN) 106 through a network 105, which can be, for example an internet protocol (IP) network. Additionally, the APs 115 may connect to other APs 115 through a wireless connection (not shown).

The wireless network 100 can include multiple clients 120 configured with a wireless device for communications to the APs 115. Additionally, wireless devices can be used for ad-hoc connections (i.e., point-to-point communications) to other clients 120 in some configurations. The clients 120 can be desktop computers, notebook computers, storage devices, printers, or any other piece of equipment that is equipped with a wireless device. Wireless devices in the clients 120 can include wireless radios capable of communicating over the wireless network 100 along with firmware and hardware to interface to the client 120. FIG. 1 depicts several clients 120 actively communicating over the wireless network 100 and a pair of clients 120 communicating with an ad-hoc wireless connection.

The wireless network 100 is monitored by the wireless security system 101 which can include a wireless sensor 110 and a server 130. In this example, the sensor 110 could be located at a central location to monitor traffic in coverage areas 140 of the APs 115. The sensor 110 can include a wireless radio configured to transmit and receive wireless data, a processing engine to analyze received data, and a communications interface to communicate processed data to the server 130. The sensor 110 can be connected to the LAN 106. Moreover, the sensor can communicate to the server 130 through the network 105 or through some other communications interface. Additionally, APs 115 and clients 120 in some examples, occasionally operate as sensors 110 and communicate to the server 130. In other examples, clients 120 can be configured with intrusion detection software agents, allowing the clients 120 to monitor the wireless network 100 and to communicate the results from monitoring the wireless network 100 to the server 130.

The wireless security system 101 can be configured to monitor data, events, and statistics on the wireless network 100. The server 130 can be configured to receive and correlate data, events, and statistics from the sensors 110, APs 115, and clients 120. The server 130 can detect attacks and events, network performance degradation, and network policy compliance.

In an example operation, a rogue wireless device 125 attempts to communicate or perform an attack on the wireless network 100. The sensor 110 can detect communications from the rogue wireless device 125 and the server 130 can analyze the received communications. Upon recognition of the rogue wireless device 125, the server 130 may raise an alarm and direct the sensor 110, client 120, or AP 115 to prevent the rogue wireless device 125 from communicating with the network devices.

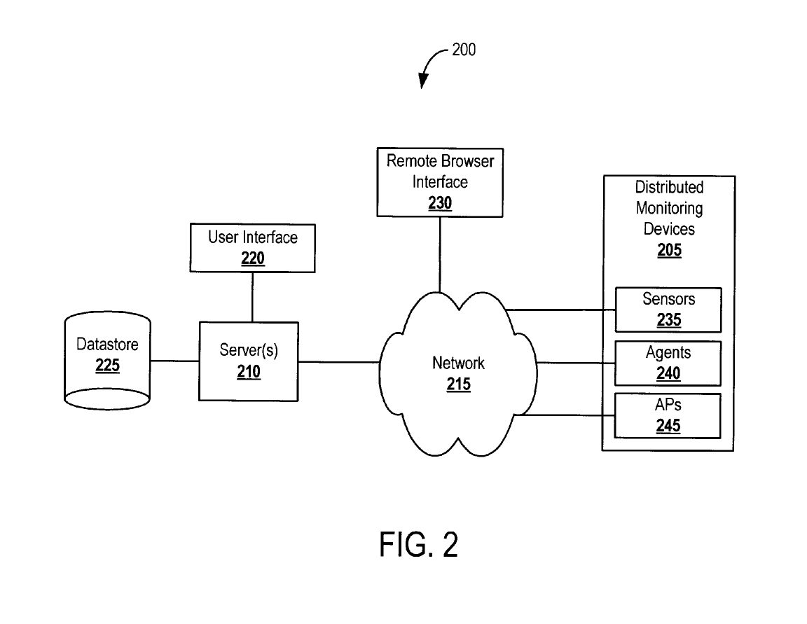

FIG. 2 is a block diagram depicting a wireless security system 200 with distributed monitoring devices 205 and a server 210 configured for wireless network forensics. The wireless security system 200 can include one or more server(s) 210 connected to a network 215. The network 215 can be, for example an internet protocol (IP) network.

The server(s) 130 can receive, via the network 215, data, events, and statistics from distributed monitoring devices 205. The server(s) 210 can be configured to correlate and aggregate data, events, and statistics from the distributed monitoring devices 205 and to detect attacks and event, alarms, performance degradation, and network policy compliance. The server(s) 210 can be connected to a data store 225 via, for example, a direct connection (e.g., internal hard-drive, universal serial port bus (USB)) or a network connection (e.g., Ethernet).

The data store 225 can include data storage for all statistics, states, events and alarms on the wireless network. The data store 225 can provide an efficient methods and systems to store and retrieve statistics, states, events, and alarms. Prior art wireless security systems can include a data store 225, however these prior art systems lack the ability to store all events, states, and alarms in the wireless network. Moreover, prior art systems lack the ability to recreate the wireless network environment for forensic investigations. The data store 225 in various examples may be an internal hard-drive, an external hard-drive, a network-attached file server, or any other data storage device.

Distributed monitoring devices 205 can include sensors 235, APs 245, and software agents 240. Each of the devices 205 can be configured to monitor a range of frequencies on a wireless network, to analyze the monitored data, and to communicate data, events, and statistics to the server(s) 210.

The APs 245 can be used to provide a relay between a wireless network and the wired network. APs 245 can connect to a wired network, but alternatively may connect to other APs 245. APs 245 can include wireless radios configured to operate over a range of frequencies, hardware and firmware to control operations and communications, and a network interface to connect to a wired network or another wireless network. In one example, APs 245 can operate in the 2.4 GHz frequency range at the channels defined in the 802.11 family of protocols. APs 245 may communicate to the server(s) 210 to provide data, events, and statistics; however APs 245 are can be used more often to provide for wireless access instead of monitoring.

The sensors 235 are wireless devices configured to monitor transmissions on a wireless network. The sensors 235 can be configured to locally analyze received packets, collect statistics and events of interest, and use an efficient interface to communicate selected events and statistics over a secure link (e.g., SSL over an IP network) to the server(s) 210. The sensors 235 can provide dedicated monitoring of the wireless network. In one example, the sensors 235 can be APs with special firmware allowing them to operate in a promiscuous mode to listen to all packets received. Additionally, the sensors may use intelligent scanning algorithms to detect which channels are active across the radio frequency (RF) spectrum, as described in detail by U.S. patent application Ser. No. 11/332,065 entitled “SYSTEMS AND METHODS FOR WIRELESS INTRUSION DETECTION USING SPECTRAL ANALYSIS” filed Jan. 13, 2006, which has been incorporated by reference.

Software agents 240 can be installed on client devices which communicate on the wireless network. Agents 240, for example, can monitor wireless activity and enforce pre-determined security policies even when the device is not within the monitored enterprise perimeter. Software agents 240 may be used in combination with APs 115 and sensors 110, but software agents typically do not provide the same amount of monitoring. In one embodiment, the software agents 240 may utilize the wireless connection on the client to monitor the wireless network while the client is idle, as described in U.S. patent application entitled “SYSTEMS AND METHODS FOR WIRELESS SECURITY USING DISTRIBUTED COLLABORATION OF WIRELESS CLIENTS,” which was filed on Mar. 17, 2006, and is incorporated by reference above.

The server(s) 210 can be accessed by a user interface 220 or a remote browser interface 230. The user interface 220 includes a direct interface on the server(s) such as the monitor. The server(s) 210 can also be accessed remotely over the network 215 through a web based interface such as, for example, MICROSOFT INTERNET EXPLORER (available from Microsoft Corp. of Redmond, Wash.).

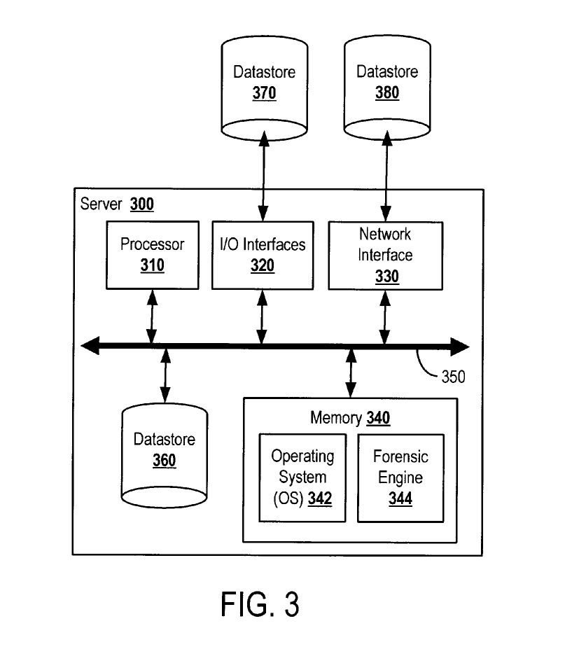

FIG. 3 is a block diagram depicting a server 300 having a forensic engine 344 connected to a data store 300. The server 300 may be a digital computer that, in terms of hardware architecture, generally includes a processor 310, input/output (I/O) interfaces 320, network interfaces 330, and memory 340. The components (310, 320, 330, and 340) are communicatively coupled via a local interface 350. The local interface 350 can be, for example but not limited to, one or more buses or other wired or wireless connections, as is known in the art. The local interface 350 may have additional elements, which are omitted for simplicity, such as controllers, buffers (caches), drivers, repeaters, and receivers, among many others, to enable communications. Further, the local interface 350 may include address, control, and/or data connections to enable appropriate communications among the aforementioned components.

The processor 310 is a hardware device for executing software instructions. The processor 310 can be any custom made or commercially available processor, a central processing unit (CPU), an auxiliary processor among several processors associated with the server 300, a semiconductor-based microprocessor (in the form of a microchip or chip set), or generally any device for executing software instructions. When the server 300 is in operation, the processor 310 is configured to execute software stored within the memory 340, to communicate data to and from the memory 340, and to generally control operations of the server 130 pursuant to the software instructions.

The I/O interfaces 320 may be used to receive user input from and/or for providing system output to one or more devices or components. User input may be provided via, for example, a keyboard and/or a mouse. System output may be provided via a display device and a printer (not shown). I/O interfaces 320 may include, for example, a serial port, a parallel port, a small computer system interface (SCSI), an infrared (IR) interface, a radio frequency (RF) interface, and/or a universal serial bus (USB) interface.

The network interfaces 330 can be used to enable the server 300 to communicate on a network. The network interfaces 330 may include, for example, an Ethernet card (e.g. 10BaseT, Fast Ethernet, Gigabit Ethernet) or a wireless local area network (WLAN) card (e.g., 802.11a/b/g). The network interfaces 330 may include address, control, and/or data connections to enable appropriate communications on the network.

A data store can be used to store alarms, events, data, state, and statistics that the server 300 receives or analyzes from devices monitoring a wireless network. The data store can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the data store may incorporate electronic, magnetic, optical, and/or other types of storage media.

In one example, a data store 360 may be located internal to the server 300 such as, for example, an internal hard drive connected to the local interface 350 in the server 300. Additionally in another embodiment, the data store 370 may be located external to the server 300 such as, for example, an external hard drive connected to the I/O interfaces 320 (e.g., SCSI or USB connection). Finally in a third embodiment, the data store 380 may be connected to the server 300 through a network, such as, for example, a network attached file server.

The memory 340 can include any of volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 340 may incorporate electronic, magnetic, optical, and/or other types of storage media. Note that the memory 340 can have a distributed architecture, where various components are situated remotely from one another, but can be accessed by the processor 310.

The software in memory 340 may include one or more software programs, each of which includes an ordered listing of executable instructions for implementing logical functions. In the example of FIG. 3, the software in the memory system 340 includes a forensic engine 344 and a suitable operating system (O/S) 342. The operating system 342 essentially controls the execution of other computer programs, such as the forensic engine 344, and provides scheduling, input-output control, file and data management, memory management, and communication control and related services. The operating system 342 may be any of WINDOWS/NT, WINDOWS 2000, WINDOWS/XP Server WINDOWS MOBILE (all available from Microsoft, Corp. of Redmond, Wash.), Solaris (available from Sun Microsystems, Inc. of Palo Alto, Calif.), or LINUX (or another UNIX variant) (such as available from RedHat of Raleigh, N.C.).

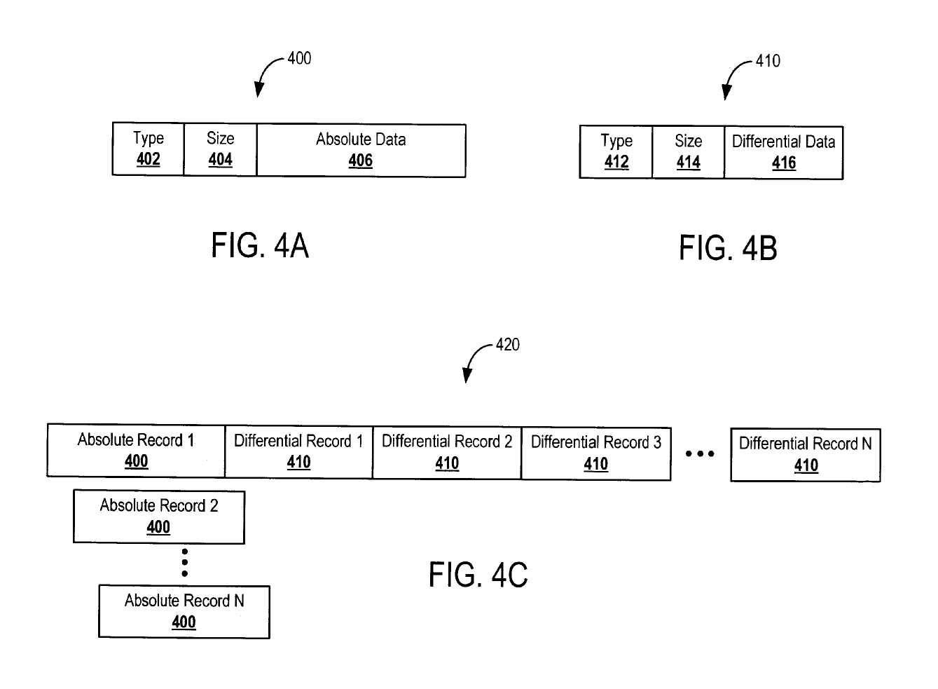

The forensic engine 344 can be a software program loaded in the memory 340 of the server 130 to enable storage and retrieval of data associated with monitoring a wireless network. The forensic engine 344 is configured to record every possible behavior, event, or statistic of wireless devices that enter a space which is monitored by the server 300. Additionally, the forensic engine 344 implements a differential data storage format (FIG. 4) in one or more of the data stores 360, 370, 380 to efficiently store data. Finally, the forensic engine 344 includes a query and expression processing ability to retrieve information from the one or more data stores 360, 370, 380. The query and expression processing ability can enables rendering of data through graphs, reports, and alarms. The query and expression processing functions can further enable playback of the radio frequency (RF) environment to recreate the behavior of a wireless device at any point in the past. These functions associated with the forensic engine 344 enable a user to create new attack definitions associated with wireless attacks without having to keep updating the core system and to define arbitrary wireless policies associated with the wireless network.

FIGS. 4A-4C depict block diagrams of an absolute record 400, a differential record 410, and a record file store 420. The basic unit of storage in a data store is the record 400, 410. The records 400, 410 can be indexed according to time. FIG. 4A depicts the absolute record 400. The absolute record 400 can include a type 402 and a size 404 that define the type and size of the absolute record 400. Absolute data 406 can include an absolute value of the data associated with the type 402 of the record. FIG. 4B depicts the differential record 410 which can include a type 412 and a size 414 that define the type and the size of the differential record 410. Differential data 416 can store a value based on the difference from a specific absolute data 406 or from a specific differential data 416 to enable more efficient data storage. In an example embodiment, a differential record 410 stores differential data 416 which is the difference between the absolute value of the differential data 416 and the data 406, 416 stored in previous records 400, 410. The previous record 400, 410 can be either an absolute record 400 or a differential record 410.

The type 402, 412 can define a category associated with data 406, 416 stored in a record 400, 410. Examples of types 402, 412 include the class of the record 400, 410 such as, for example, whether the record is a global record system level variable or whether the record is associated with a particular instance or class of event. Examples of global variables include system level variables, system level alarms, and other miscellaneous variables. Examples of particular instance or class of events include specific access point (AP), sensor, channel, and station level variables such as, for example, channels, signal strength, supported rates, total frames transmitted/received, frame counts by categories/rates, and encryption mode. The type 402, 412 can be updated to add new types as needed.

FIG. 4C depicts an example embodiment of a record file store 420. The record file store 420 includes multiple absolute records 400 and associated differential records 410. In an example embodiment, the record file store 420 can be stored in a data store as depicted in FIGS. 2-3 (any of data stores 210, 360, 370, 380). For each type of data, the record file store 420 starts with an absolute record 400 followed by several differential records 410 which store data derived from previous records 400, 410.

Absolute records 400 can be aligned on page boundaries. Page size, which sets page boundaries, can be a system configurable parameter. The use of differential records can significantly reduce the storage size associated with the records 400. In an example embodiment, there are absolute records 400 for the types 402, 412 of data. New data is stored as differential records 410 based on the previous absolute record 400 and differential records 410 of the same type 402, 412. For example, the data may be a simple difference between the current value and the value in the immediately preceding record 400, 410.

Periodically, absolute records 400 can be introduced for retrieval efficiency. For example, there may be only one absolute record 400 for each type 402, 412 and numerous differential records 410 of the same type 402, 412. However, the system may based on configurable parameters insert a new absolute record 400 to improve efficiency in the storage and retrieval of differential records 410.

To obtain the absolute value of a statistic, state, event, or alarm stored in a specific differential record 410, the system can retrieve a set of previous records 400, 410, and calculate the difference between the specific differential record 410 and the set of previous records 400, 410. In an example operation, there may be one previous differential record 410 and one previous absolute record 400. To obtain the absolute value of a second differential record 410, the difference is taken between the second differential record 410 and the previous differential record 410 and then the difference from the absolute record 400. A file store 420 can significantly reduce the size of a data store, enabling storage and retrieval of all events associated with the monitoring of a wireless network.

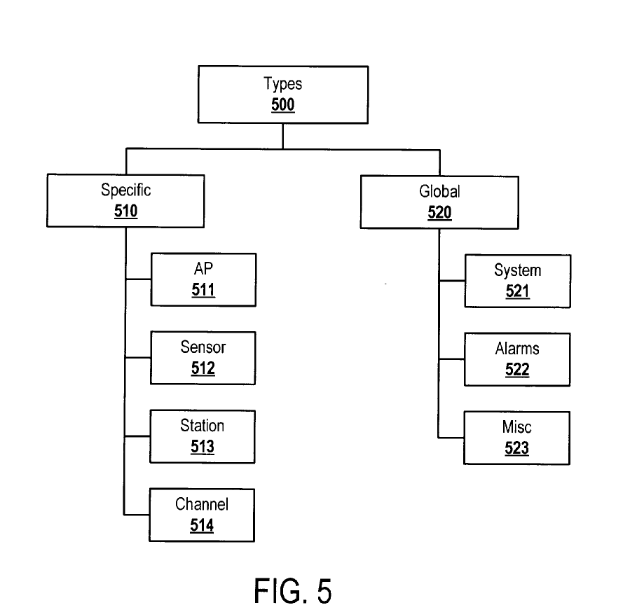

FIG. 5 depicts an example of the hierarchy of the types 500 of variables associated with monitoring a wireless network that can be stored in a data store. The types 500 can be classified between specific instance 510 variables and global 520 variables.

The global 520 variables can be associated with the system level monitoring of the wireless network and include system level variables 521, alarms 522, and miscellaneous variables 523. The specific instance variables 510 are associated with a specific device or event on the wireless network and can include access point (AP) variables 511, sensor variables 512, station variables 513, and channel variables 514. For example, AP variables 511 and sensor variables 512 could be the channel, signal strength, supported rates, total frames transmitted/received, frame counts by categories/rates, encryption mode, among others. In another example, station variables 513 could be an internet protocol (IP) address, virtual local area network (VLAN) information, switch port, operating system information, among others. The types 500 of variables can be expanded as new data is monitored for forensic analysis.

In an example embodiment, the total number of unique types 500 of variables can be 1670. Specific instance variables 510 can be repeated for each device in the wireless network. For example, a wireless network with ten APs and five sensors would have a corresponding number of specific instance variables 510 for each of the fifteen devices.

Data stored in the records can be static, semi-static, or dynamic, in various examples. Static data does not change over time. Semi-static data is generally stationary but could change periodically, for example, when a particular configuration is updated. Using absolute records and associated differential records dramatically decreases the storage space as the number of specific instances 510 of a particular device increases. In one implementation, using differential records resulted in the average storage requirement per wireless device being monitored being reduced by a factor of 40.

Variables stored in the absolute records 400 and differential records 410 can be updated and recorded based on a configurable system epoch. For example, the epoch could be set to one minute. A smaller epoch results in better timing resolution but increases the storage requirements since more records are created per unit time.

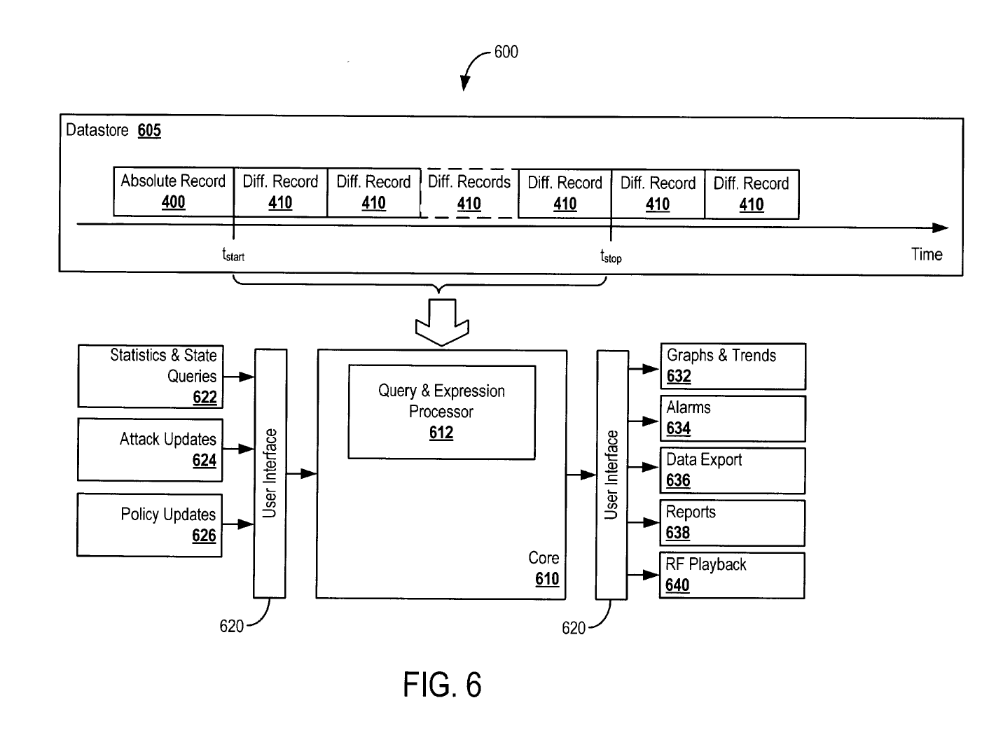

FIG. 6 depicts a block diagram of an embodiment of a forensic analysis engine 600. The forensic analysis engine 600 can be configured to retrieve data stored in absolute and differential records for display and analysis. The forensic analysis engine 600 can include a data store 605 having stored records 400, 410, a user interface 620, a core 610, and a query and expression processor 612 within the core 610. The data store 605 can be similar to the data stores depicted in FIGS. 2 and 3, and can contain absolute records 400 and differential records 410 for each type of variable associated with monitoring a wireless network.

The user interface 620 can provide a user access to the forensic analysis engine 600 to control the storage, retrieval, and analysis of the associated data in the data store 605. For example, the user interface 620 may include a local interface such as, for example, a monitor and keyboard attached to a server running the forensic analysis engine 600. Additionally, the user interface 620 may include a remote interface such as a web graphic user interface that the user access through a network connection.

The core 610 is configured to provide the user interface 620, to retrieve and store records 400, 410 in the data store 605, and to process queries and expressions through the query and expression processor 612. In one embodiment, the functionality of the core 610 can be performed by one or more servers, and the query and expression processor 612 can be performed by a processor associated with the server(s).

The user, via the user interface 620, can implement statistics and state queries 622, attack updates 624, and policy updates 626. Statistics and state queries 622 can include commands to parse and display records 400, 410 from the data store 605. For statistics and state queries 622, a user specifies a query based on the desired statistics and states that the user wants to investigate. For example, a query could be “show me transmit and receive frames per minute for this particular access point (AP) in this time span”. Complicated queries can be built using regular expressions and conditions.

In an operational example of the forensic analysis engine 600, the user inputs a query 622 through the UI 620. The query and expression processor 612 parses the query and requests the relevant records 400, 410 from the data store 605. For example, the processor 612 retrieves all relevant absolute and differential records and expands differential records to their associated absolute values. The forensic analysis engine 600 displays the query 622 on the UI 620 in the form specified by the user (e.g., graphs and trends 632, alarms 634, and reports 638).

New attack updates 624 can also be specified using the same expression and query framework. For example, the output of a query like “find devices where signal strength changed abruptly and frame sequence numbers were out of sync” could be used to trigger identity theft alarms. Similarly, wireless policy updates 626 could be defined. For example, a policy violation alarm could be simply defined with an expression that returns “find all APs where unencrypted data frames are non zero”.

The forensic analysis engine 600 can output graphs and trends 632, alarms 634, data export 636, reports 638, and radio frequency (RF) playback 640 based on retrieved records from the data store 605. The forensic analysis engine 600 can use the user interface 620 to display the output to the user. In one embodiment, the forensic analysis engine 600 operates on the server(s) and the data store 605.

The forensic analysis engine 600 can output graphs and trends 632, alarms 634, data export 636, reports 638, and radio frequency (RF) playback 640 over a network connection or a local input/output (I/O) device such as, for example, a local monitor, file server, a printer, etc. The data export 636 feature can enable raw data to be exported in user defined formats. RF playback 640 can enable the behavior of a particular device to be re-created over a given span of time such as, for example, the physical location, association pattern, and data transfer rates could be visualized on a map during a given duration of time.

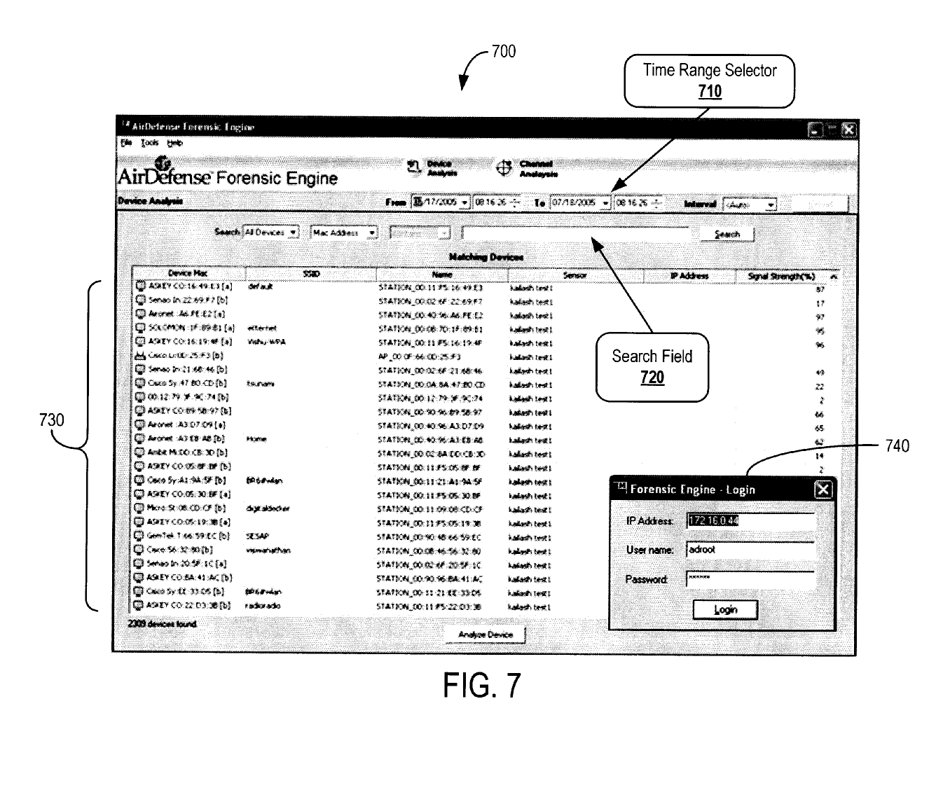

FIG. 7 illustrates an example screen shot of a forensic user interface (UI) screen 700. The UI screen 700 includes a time range selector 710, a search field 720, data 730, and a login prompt 740. The login prompt 740 provides secure access to the UI screen 700. The time range selector 710 allows a user to specify a time interval for the data 730 and the search field 720 allows the user to specify a query. Example queries may include secure set identifier (SSID), media access control (MAC) address, name of device, among others. Through the UI screen 700, the user may use predefined expressions and queries to generate reports.

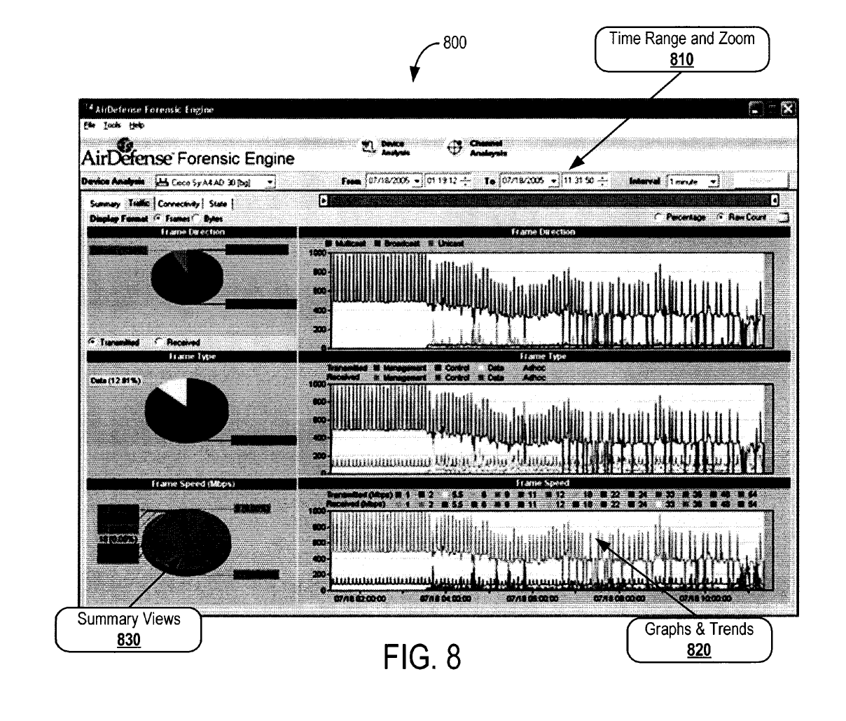

FIG. 8 illustrates an example screen shot of a forensic user interface (UI) screen 800 depicting graphs and summary views of an example query. The UI screen 800 includes a time range and zoom 810, graphs and trends 820, and summary views 830. UI screen 800 can be used in conjunction with the data query as depicted by UI screen 700 (FIG. 7) to generate graphical and summary views of data.

What is claimed is:

1. A method for storing data associated with monitoring a wireless network, the method comprising the steps of:
a) receiving data from distributed monitoring devices;
b) classifying the data by type;
c) determining if a new absolute record is to be created based upon the type and upon a period since a previous absolute record was created;
d) based upon step c), storing the data in an absolute record indexed to the type and time;
e) storing the data in a differential record indexed to the type and time, wherein the differential record is derived from previous differential and absolute records of the same type and
f) repeating steps a) through e)

2. The method of claim 1, further comprising the steps of:
a) submitting a query based on a plurality of types of data and a time interval;
b) retrieving a set of absolute and differential records responsive to the query;
c) calculating the absolute value of the set of differential records, wherein the absolute value comprises the difference between the differential record and the previous absolute record.

3. The method of claim 1, wherein a new absolute record is created by step d) when either no absolute record exists for the type or a predetermined number of differential records exists associated with a previous absolute record for the type.

4. The method of claim 3, wherein the predetermined number of differential records is determined responsive to the efficiency of storage and retrieval of the differential records.

5. The method of claim 2, further comprising the step of displaying the query results, wherein the query results comprise the set of absolute records and the absolute values of the set of differential records.

6. The method of claim 5, wherein the query results are provided as graphs, trends, reports, alarms, and combinations thereof.

7. The method of claim 6, wherein the displaying step is performed on a user interface, wherein the user interface is accessed through one of a local server and a web browser.

8. The method of claim 1, wherein the distributed monitoring devices comprise any of sensors, access points, clients equipped with monitoring agents, and combinations thereof

9. The method of claim 5, wherein policy violations are identified by running a query, wherein the query identifies the desired policy.

10. The method of claim 5, wherein attack updates are performed by running a query, wherein the query is responsive to the desired attack.

11. The method of claim 5, wherein the wireless network radio frequency (RF) environment is recreated over a predetermined time interval by running a plurality of queries.

12. The method of claim 11, wherein the RF environment is displayed on a user interface.

13. The method of claim 1, wherein the data is stored in a data store coupled to one or more servers.

14. A method for storing data associated with monitoring a wireless network in association with performing wireless network forensics, the method comprising the steps of:
a) receiving a type of data wherein the data comprises forensic information relating to the wireless network;
b) storing an absolute record of a type of data at a set time; and
c) storing subsequent data of the same type in a differential record, wherein the differential record is based on the previous absolute record.

15. The method of claim 14, further comprising the step of retrieving a plurality of absolute and differential records responsive to a query and parsing the plurality of differential records to obtain absolute values.

16. A method of performing wireless network forensics, the method comprising the steps of:
a) submitting a query of wireless network forensic data based on a plurality of data types and a time interval;
b) parsing a set of differential and absolute records responsive to a query; and
c) displaying the plurality of records that satisfy the submitted query.

17. The method of claim 16, wherein the plurality of records comprise a plurality of absolute and differential records and wherein the differential records are stored as the difference from an absolute record.

18. A wireless network forensics system, the system comprising:
a) a data store operable to store records; and
b) a network interface coupled to a network;
c) a system processor comprising one or more processing elements, wherein the system processor is in communication with the data store and the network interface and wherein the system processor is programmed or adapted to:
i. store data received from the network, wherein the data comprises forensic information relating to a wireless network;
ii. accept queries and expressions;
iii. retrieve and parse data from the data store; and
iv. display data responsive to queries and expressions.

19. The wireless network forensics system of claim 18, the system further comprising a plurality of distributed monitoring devices in communication with the network interface.

20. The wireless network forensics system of claim 19, wherein the plurality of distributed monitoring devices comprises one or more sensors, access points, clients equipped with monitoring agents, or combinations thereof.

21. The wireless network forensics system of claim 18, the system further comprising a user interface and a remote browser interface.

22. The wireless network forensics system of claim 19, wherein the data comprises events, statistics, data, alarms, or combinations thereof received from the plurality of distributed monitoring devices.

23. The wireless network forensics system of claim 22, wherein the data is stored in a plurality of absolute and differential records indexed to data type and time.

24. The wireless network forensics system of claim 23, wherein the differential records comprise a value calculated based on a previous absolute record.

25. The wireless network forensics system of claim 24, wherein a new absolute record for a data type is stored when there is one of no absolute record of the data type, there is a page break in the data store, or a predetermined number of differential records of the data type have been stored.
